(19) United States
(12) Patent Application Publication
(10) Pub. No.: US 2026/0099506 A1
(43) Pub. Date: Apr. 9, 2026

(54) Fast-forwarding Binary Data through a Distributed Microservice Architecture

(71) Applicant: Ciena Corporation, Hanover, MD (US)

(72) Inventors: Quantum Hu, Toronto (CA); David Miedema, Ottawa (CA); Emily Michelle Mulvihill, Ottawa (CA)

(73) Assignee: Ciena Corporation, Hanover, MD (US)

(21) Appl. No.: 18/908,960

(22) Filed: Oct. 8, 2024

(51) Int. Cl. G06F 16/25; G06F 9/54

(52) U.S. Cl. CPC G06F 16/258; G06F 9/547

(57) ABSTRACT

Systems and methods are provided for fast-forwarding binary data through a chain of microservices. A requester microservice may be arranged at one endpoint of a microservice chain while a provider microservice may be arranged at the other endpoint. The provider microservice, for example, may be configured to execute various data transmission methods. According to one implementation, a method may include receiving a request from the requester microservice to obtain binary data formatted in a specific data format. The method may include converting the binary data from a native data format to the specific data format as requested by the requester microservice. In addition, the method includes adding a tag with the binary data, wherein the tag is configured to instruct each intermediate microservice along the microservice chain to bypass a Serialize/Deserialize (SerDes) stage therein while forwarding the binary data to a next microservice in the microservice chain.

### FIELD OF THE DISCLOSURE

The present disclosure generally relates to networking and computing systems. More particularly, the present disclosure relates to systems and methods for bypassing Serialization/Deserialization (SerDes) stages, among other common processing stages, for fast-forwarding binary data from one end of a microservice chain to the other.

### BACKGROUND OF THE DISCLOSURE

Many schemas support data encoding strategies that can convert an internal data structure to a format that can be sent on the wire. Encoding formats like JavaScript Object Notation (JSON), eXtensible Mark-up Language (XML), protobuf, Google's Remote Procedure Call (gRPC) Network Management Interface (gNMI), flat buffers, and others are typically intended to be used for a messaging layer only and once received, the entire message is consumed and is converted to an internal format. Some schemas allow binary data to be encoded, but there are limitations on how raw binary data can be represented in the data formats. For example, Yet Another Next Generation (YANG) Requests for Comments (RFCs) have a binary data type which involves serializing and deserializing the data in Base64 encoding, which is not a fast encoding process. Other methods can be used to send binary data as files or other encoded data, but it is rare that systems are designed to accept opaque binary data on a messaging interface and allow it to flow undecoded through the entire system. Also, binary encoding schemes, like protobuf, can encapsulate raw binary data in an internal Type-Length-Value (TLV) format, but the data must be copied into the internals of a buffer on the sending side, and copied out of the received buffer on the receiving side. As a result, Base64 encoding is less efficient than raw binary data, as there are computing resources and time involved in converting back and forth between a messaging-compatible and non-compatible format. Also, normal data encoding does not allow for opaque binary data to be easily encoded and embedded in a message. References to binary data (e.g., filename, URL, etc.) can be sent and the data transferred via a separate message, but this is less efficient than sending the raw data in the message itself. The embedding of binary data in the contents of a binary encoding schema also forces copies into and out of the buffer when the data is translated.

### BRIEF SUMMARY OF THE DISCLOSURE

The present disclosure relates to systems and methods for “fast-forwarding” binary data through a chain of microservices. Methods may be executed by various components that may be arranged in the chain of microservices, where the components may include processors, computers, servers, Network Elements (NEs), nodes, etc. In particular, the methods may be performed by a “provider microservice” that is arranged at one end of the chain and that is configured to receive a request for binary data from a “requester microservice” at the other end of the chain. In addition to returning the requested binary data, the provider microservice is also configured to at least apply a tag that indicates to intermediate microservices up the chain merely forward the binary data to the next microservice while avoiding extra processing steps, such as memory allocation, copying, etc.

One process, according to various implementations, may include a step of receiving a request from a requester microservice to obtain binary data formatted in a specific data format. The process may further include a step of converting the binary data from a native data format to the specific data format as requested by the requester microservice. Also, the process may include a step of adding a tag with the binary data, the tag being configured to instruct each intermediate microservice along the microservice chain to bypass a Serialize/Deserialize (SerDes) stage therein while forwarding the binary data to a next microservice in the microservice chain.

According to some embodiments, the tag may be further configured to instruct each intermediate microservice along the microservice chain to bypass one or more steps associated with at least one of a binary-to-text decoding stage, a text-to-binary re-encoding stage, a memory allocation stage, and a data copying stage therein. In some embodiments, each microservice of the microservice chain may include a microprocessor and may be associated with an embedded system, node, or NE that is part of a distributed system. Also, in alternative embodiments, the microservice chain may be configured in a system having a single processor and shared memory address space, wherein the tag may be related to a pointer that points to locations within the shared memory address space.

Furthermore, according to various implementations, the native format and the specific data format may be categorized as flexible, schema-agnostic formats used for transmitting management information in a control plane. The flexible, schema-agnostic formats, for example, may include JSON, XML, YAML, and/or other various formats. Alternatively, the native format and the specific data format may be categorized as inflexible, firmly structured formats for transmitting data traffic in a data plane. The inflexible, firmly structured formats, for example, may include JPEG, GIF, protobuf, TCP, IP, IEEE 802.3 Ethernet packets, and/or other various formats.

In some embodiments, the tag may be configured as metadata and stored or encapsulated in a header or footer. The tag may be configured to instruct the intermediate microservices to fast-forward the binary data in an opaque manner, avoid conversion to Base64 format, and bypass a plaintext serialization stage. The binary data, for example, may include a data file, a picture file, pre-serialized data, generated data, performance logs, a word processing document, and/or other types of data. Upon adding the tag, the process may further include a steps of performing a pre-serialization of the binary data and passing the pre-serialized binary data and tag to a neighboring microservice in the microservice chain. In some embodiments, the tag may enable the neighboring microservice and/or intermediate microservices to reduce overhead, reduce CPU cycles, reduce memory allocation actions, reduce copying actions, reduce pointer freeing actions, reduce comparison actions, reduce filtering actions, reduce logging actions, and/or reduce debugging actions.

Furthermore, according to some embodiments, the request is a binary version of a get command that is passed along the microservice chain from the requester microservice to the provider microservice. The process may further include a step of pre-formatting the binary data in a binary buffer with a reference pointing to a shared memory address space, wherein the reference may be stored as metadata and included as a footer or header with respect to a payload related to the binary data to be transmitted through the microservice chain. The metadata, for example, may include an indication of at least what portions of a message contain the binary data, where the binary data is contained in the message, and a number of bytes of the binary data.

The process, in some embodiments, may further include steps of a) sending gNMI data, b) configuring the resource owner as a modem to generate a constellation, c) sending the binary data transparently without encoding, and/or d) encrypting the binary data that intermediate microservices cannot access but can only forward the binary data opaquely, whereby the requester microservice is able to decrypt the encrypted binary data. The binary data, in some cases, can include multiple chunks or blobs of data concatenated together, wherein the process may further include a step of incorporating metadata with the binary data to define each chunk or blob.

### BRIEF DESCRIPTION OF THE DRAWINGS

The present disclosure is detailed through various drawings, where like components or steps are indicated by identical reference numbers for clarity and consistency.

FIG. 1 is a block diagram illustrating an example of a microservice chain.

FIG. 2 is a block diagram illustrating a data processing procedure, according to various embodiments.

FIG. 3 is a block diagram illustrating another data processing procedure, according to various embodiments.

FIG. 4 is a block diagram illustrating another data processing procedure, according to various embodiments.

FIG. 5 is a block diagram illustrating yet another data processing procedure, according to various embodiments.

FIG. 6 is a block diagram illustrating a computing system associated with a node or microservice in a chain for transmitting data, according to various embodiments.

FIG. 7 is a flow diagram illustrating a process for transmitting data in a “fast-forward” manner, according to various embodiments.

### DETAILED DESCRIPTION OF THE DISCLOSURE

In software engineering, “microservices” can be configured is an architectural pattern that arranges an application as a collection of loosely coupled, fine-grained services. Communication through a chain of microservices may involve the user of flexible and/or lightweight protocols. A distributed microservice-based architecture enables software development teams to generate and deploy their services independently. Also, such an architecture reduces code interdependencies and increases readability and modularity within a codebase and can reduce complexity. Consequently, organizations can develop software with rapid growth and scalability, as well as implement off-the-shelf services more easily. These benefits come with the cost of needing to maintain a decoupled structure within the codebase.

In some examples, embedded systems may be configured with a microservice architecture. Embedded systems, including processing and memory capabilities, can transmit data between endpoints for messaging. In particular, the transmitted data typically follows a rigid structure or schema. Messaging with schemas, in some cases, is not recommended for transmitting different types of binary, which may be referred to herein as “arbitrary binary data.” Examples of arbitrary binary data may include, but are not limited to, pictures, pre-serialized data, performance logs, documents, and the like. It should be noted that the content of arbitrary binary data may quite varied, whereby inserting this content directly in the body or payload of a message can cause problems for the decoder at the receiving end. Also, for plaintext serialization, binary data must be converted to escaped and encoded data that can exist as a string (e.g., in Base64), where escaped and encoded data may be identified using characters such as backslashes and quotes in software code.

As such, specific data formats for the binary data can be selected and used. Data formats may exhibit at least the following two characteristics:
(1) The converted data can be readily transmitted over the network, and
(2) The converted data can be consistently converted back to a usable format once the data arrives on the receiving end.

Also, data formats exhibiting these characteristics generally fall into two categories:
(1) schema-resistant (or schema-agnostic) “compatible” (or flexible) formats, such as JSON, XML, YAML, etc. These data formats, for example, may be used with respect to transmit management information traffic, such as in a control or management plane. This first category of data formats may be considered to be “compatible” or “flexible” because there are no requirements for a schema to exist in order to send or receive data.
(2) firmly structured (or schema-following) “incompatible” (or inflexible) formats, such as Google-designed protobuf, or industry-standardized formats, such as JPEG, GIF, IEEE 802.3 Ethernet packets, etc. These data formats, for example, may sacrifice flexibility for speed in some cases.

In both format categories, an arbitrary collection of binary bytes is usually converted to a transmittable format. For flexible formats, such as JSON, this conversion process takes time and computing resources are often encoded into a format such as Base64, which allows for the correct representation of the binary data in pure ASCII text characters. For inflexible formats, such as Google protobuf, the data is copied, and a simple protobuf-unique header is prepended to the data to signify that the upcoming data is a series of bytes having length X. This formatting saves encoding time compared to Base64, but still requires data to be copied, a relatively computationally expensive operation if done frequently. One detail is that both formats typically require a memory allocation, in addition to compatible formats needing to perform an encoding operation while incompatible formats perform a copy operation.

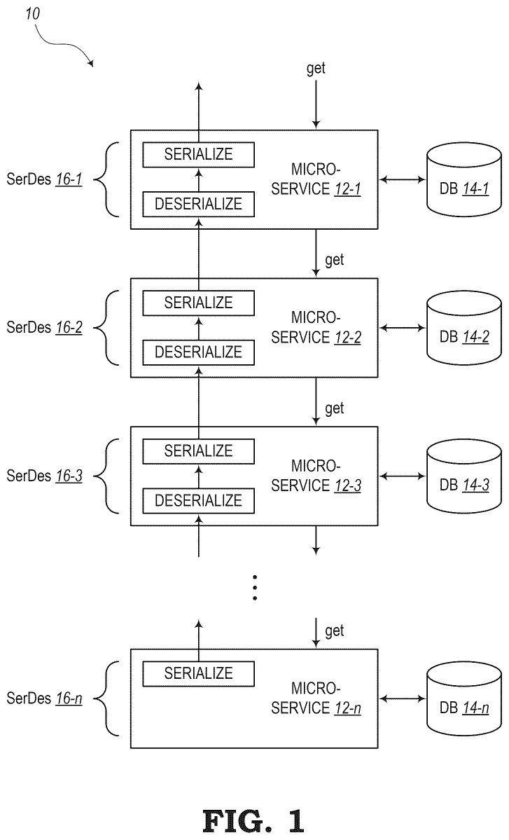

FIG. 1 is a block diagram illustrating an example of a microservice chain 10 having a plurality of microservices 12-1, 12-2, 12-3, . . . , 12-n. Each microservice 12-1, 12-2, 12-3, . . . , 12-n may be associated with a corresponding database 14-1, 14-2, 14-3, . . . , 14-n. Also, the microservices 12 may include a corresponding Serializer/Deserializer (SerDes) 16-1, 16-2, 16-3, . . . , 16-n, respectively. Each SerDes 16 includes a serializing portion and a deserializing portion. In this example, the microservice chain 10 includes a number (n) of microservices, wherein the first microservice 12-1 is arranged at a first endpoint and the last microservice 12-n is arranged at a second endpoint. According to various implementations, the first microservice 12-1 may be considered to be a “requester microservice” for requesting binary data and the last microservice 12-n may be considered to be a “provider microservice” for providing the requested binary data through the microservice chain 10 to the requester microservice.

Thus, in operation, a “get” command may be received at the first microservice 12-1 for obtaining binary data that is stored in the database 14-n of the last microservice 12-n. In addition, the get command may include instruction for converting the binary data, if necessary, to a specific data format (e.g., JSON, XML, YANG, etc.). However, according to conventional systems, information regarding the requested data format is not passed through the microservice chain 10. Instead, according to typical strategies of conventional systems, each microservice 12 is configured to deserialize and serialize data in order to enable communication with its adjacent microservice. That is, each microservice 12, at each level along the microservice chain 10, will utilize its respective SerDes 16 based on the format in which the data was received and based on the format that enables communication to the next microservice 12. Therefore, in the conventional systems, the get command is forwarded through the microservice chain 10 (from top to bottom) until it reaches the last microservice 12-n. Then, the last microservice 12-n is configured to retrieve the requested binary data and serialize it for transport to the next higher microservice 12. Again, the microservice 12 at each level deserializes and serializes the data, along with copying steps involving its respective database 14 and other steps, before passing the data along to the next microservice 12.

However, according to the embodiments of the present disclosure, the SerDes 16 stage can be bypassed at most levels of the microservice chain 10. That is, information regarding the requested data format, which is received in the original get command at the first microservice 12-1, can be passed with the get command down to the last microservice 12-n. Then, the last microservice 12-n can retrieve the requested binary data from database 14-n and utilize the serialize component of its SerDes 16-n to serialize the data according to the requested data format. In addition, the microservice 12-n is configured to add a tag (or flag) to the binary data, whereby the tag can be considered as a “fast-forward” flag that indicates to each intermediate microservice 12 to simply forward the data while bypassing its SerDes 16 stage. Thus, bypassing the SerDes 16 reduces the number of times that the data is deserialized, re-serialized, copied into the database 14, allocated into memory, among other procedures. The data can be quickly and more efficiently transported back to the top of the microservice chain 10. Note, while the term tag is used herein, those skilled in the art will recognize this can be any identifier used to denote the desire to “fast-forward” the associated binary data.

According to various embodiments, the present disclosure aims to improve upon the two format categories (i.e., flexible and inflexible formats) by eliminating most memory allocation, encoding, and copy operations. The feature of “fast-forwarding” references how binary data can skip the normal serialization process of a format and be directly transmitted and used as a pointer combined with a length value. The feature of “fast-forwarding” is “fast” in comparison to the normal serialization process, namely taking less time and/or resources to perform. For microservices, which may act solely as routers or proxies for other services, this means that the binary data can be directly extracted from a message, passed through the system in an internal format, and sent to an external client without decoding the contents of the binary encoded data, and copying the data as little as possible in the process.

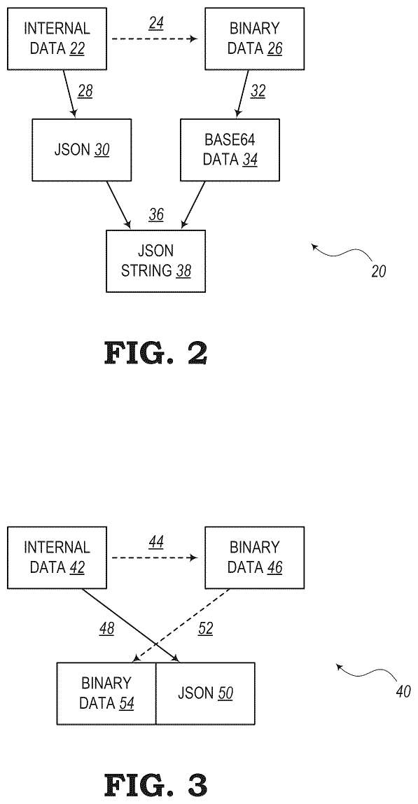

FIG. 2 is a block diagram illustrating an example of a procedure 20 for processing data within a microservice for converting the data to a particular data format. The term “Internal Data,” as shown in FIGS. 2-5 is meant to refer to examples of data in an internal format belonging to the specific microservice. This internal data is also configured to reference a binary chunk or blob of data. In FIG. 2, the internal data 22 includes a reference 24 to binary data 26. The internal data 22 is converted in a conversion step 28 to JSON 30. In this procedure 20, the binary data 26 is also encoded in an encoding step 32 to Base64 data 34. The procedure 20 also includes a combining step 36 to arrive at a final JSON string 38 by combining JSON 30 with the Base64 data 34. Thus, in total, the procedure 20 includes (costs) three separate memory allocations (i.e., associated with the conversion step 28, encoding step 32, and combining step 36) and one encoding operation (i.e., encoding step 32). However, as described in the embodiment of the present disclosure, the number of memory allocation steps and encoding steps can be reduced, particularly in the intermediate microservices 12 positioned between the first microservice 12-1 and the last microservice 12-n.

FIG. 3 is a block diagram illustrating an embodiment of a procedure 40 for improving upon conventional systems that abide by various protocols that normally include multiple memory allocation steps, encoding steps, etc. In contrast to the conventional systems, the procedure 40 can use strategies that allow a reduction in the number of costly (e.g., with respect to time, CPU utilization, power consumption, etc.) actions performed at each level of a microservice chain, such as microservice chain 10 of FIG. 1. As such, the procedure 40 may be considered to be one embodiment of the fast-forwarding strategy described in the present disclosure and may be implemented at any microservice level within a microservice chain.

Specifically, the procedure 40 includes internal data 42, which contains a reference 44 to binary data 46. The format of the internal data 42 is converted in a conversion step 48 to JSON 50, which can be configured as payload and/or may contain any suitable format that is readable and machine parsable. However, the JSON 50 contains only a reference 52 to the binary data 54. The reference 52 can merely be copied to the binary data 54 to prepare the data to be ready for transmission. Thus, the data is never encoded nor is it copied in a database, saving at least two memory allocation operations, an encoding operation, and a copy operation. The JSON 50 is simultaneously configured as a footer for the binary data 54, which represents its location in the model, as well as a container for any other internal data present.

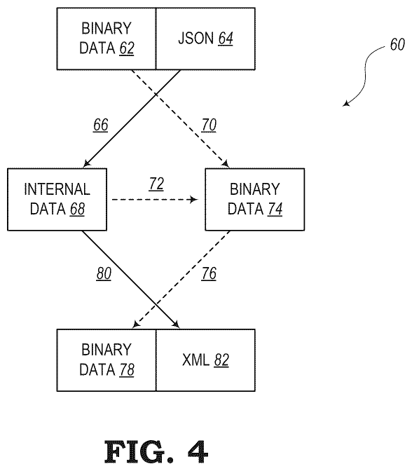

FIG. 4 is a block diagram illustrating an embodiment of a procedure 60 for processing data and converting data formats by any suitable microservice at any level within a microservice chain. In this embodiment, the procedure 60 includes starting with binary data 62 with JSON 64 as a footer. The JSON 64 may include a memory allocation 66 to internal data 68. Also, the binary data 62 may be forwarded 70 to binary data 74 at the next operational level. At this level, the internal data 68 contains a reference 72 to the binary data 74. The binary data 74 is forwarded 76 to binary data 78 at the next operational level. Also, the internal data 68 includes a memory allocation 80 to XML 82, which may be configured as a footer to the binary data 78. Thus, this procedure 60 demonstrates how the JSON 64 can be unpacked to the internal data 68 format, while keeping the reference 72 to the binary data 74. Also, the internal data 68 format can be serialized to XML, again keeping the reference to the binary data 78.

It should be noted that the formats of JSON and XML in the embodiments of FIGS. 2-4 are not meant to be limited to merely these formats. Instead, these formats are shown and described merely for illustration purposes only. However, according to other embodiments, the formats can be any arbitrary formats and can be incorporated in the body of the data string as a footer (or header) as long there is an indication of what data in the message is binary, where the data is in the message, and how big the binary data is.

Therefore, the embodiments of FIGS. 3 and 4 may have some immediate benefits with respect to the embodiment of FIG. 2 at the receiving end (i.e., the “requester microservice,”microservice 12-1, etc.):
(1) The transmitted data structure passed up to microservice code can simply be a pointer to the received message. The binary data can be directly readable and useable, which can save an additional copy operation and free operation, whereby the free operation may refer to freeing a pointer when a reference count reaches zero.
(2) The transmitted data structure used by microservice code can be readily passed around as normal, where the pointers may be freed when no references are left.
(3) The transmitted data structure can be serialized and deserialized back and forth with no additional memory allocation penalty for the binary data portion. In some cases, the binary data portion can be quite large.

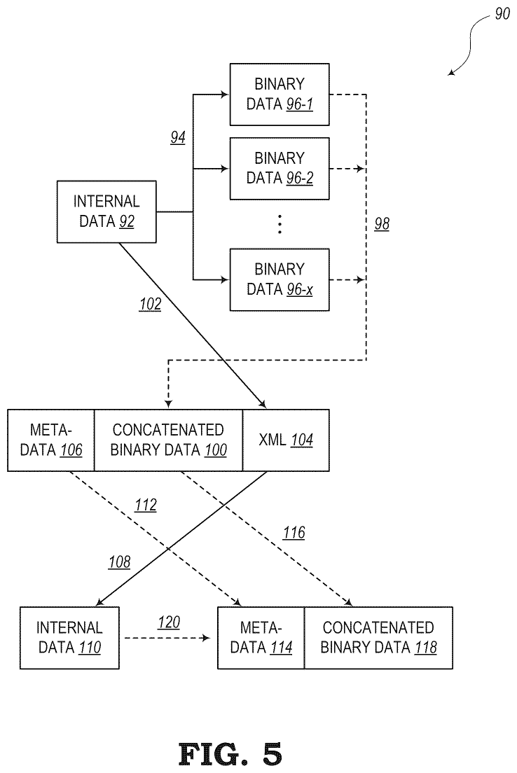

FIG. 5 is a block diagram illustrating an embodiment of a procedure 90 for processing data as performed by any suitable microservice at any level within a microservice chain. Data represented in this procedure 90 may implement a performance-oriented fast-forwarding format, which may “flow” within a microservice and support all the normal things that messages and data need to support. Functions like copy, free, comparison, filtering, logging, debugging, etc. may all be supported for content that contains binary data for fast forwarding.

Of these functions, copy and free operations are the most common and the most resource intensive, especially if the binary data is large (as would normally be the case in many fast-forwarding use cases). To support copy and free operations, two implementations are proposed that can be made for this internal representation, as described below.

In a first implementation, the metadata's relative position to the binary data may be important. In some embodiments, the position as a footer may be selected. In this respect, because allocated memory cannot be freed from within a block of memory, the metadata is able to be detached and discarded without re-allocating and copying the binary data. Allocated memory can be shortened to a smaller block of memory. Also, once the metadata (in the footer) is processed from the data-format on the wire to an internal representation, the address obtained from the message may be the same address as the one used in the internal representation. This will avoid separate copy or free operations to move the data from the messaging layer to the internal representation. Similarly, when the internal representation is being converted to a format usable in a messaging layer (where the footer is converted from an internal structure to a data format on the wire), the address used in the message to be sent can be the same as the address used in the internal representation, which again can save another copy (i.e., reduce the number of copy operations by one).

In a second implementation, copy/free operations can be reduced as much as possible. Since the data may be large and it is beneficial to avoid doing large copy operations and free operations of the data as it moves throughout the system, one approach is to use a reference counter for the binary data that can be incremented every time a block is “copied” and decremented every time the block is “freed.” When there are no outstanding references to the data, the data block can be freed.

This approach, according to these two implementations, can be extended to messages containing references to multiple chunks of binary data, as shown in the procedure 90 of FIG. 5. Internal data 92 can include references 94 to multiple chunks of binary data 96-1, 96-2, . . . 96-x. The multiple chunks can be combined 98 and configured as concatenated binary data 100. The internal can be formatted 102 as XML 104 (or another suitable format). Also, at this second level of operation in the respective microservice, metadata 106 can be prepended to the concatenated binary data 100 and XML 104. When converted to an over-the-wire format, the chunks of binary data 96-1, 96-2, . . . , 96-x can be sent concatenated with each other, with the metadata 106 describing each chunk.

The XML 104 may be forwarded in a forwarding step 108 to internal data 110 in the next level. Also, the metadata 106 may be forwarded in a forwarding step 112 in the next level to metadata 114 and arranged as a header. Also, when converted back to an internal format, the chunks of binary data are not split up due to the requirement of avoiding copies and memory allocations. Instead, they may be kept in one single chunk (e.g., concatenated binary data 118) with the metadata 114 (newly encoded) pointing to all potential chunks and reference counts that keep track of the single chunk as opposed to individual chunks. The internal data 110 may include a reference 120 to the body of data including the metadata 114 and concatenated binary data 118.

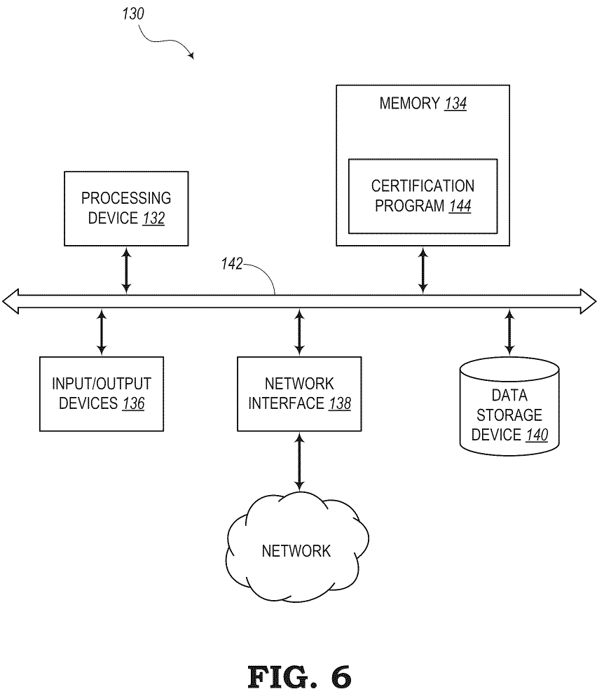

FIG. 6 is a block diagram illustrating an embodiment of a computing system 130 associated with any node, NE, or microservice that may be arranged in a microservice chain for transmitting data from one end of the chain to the other. In the illustrated embodiment, the computing system 130 may be a digital computing device that generally includes a processing device 132, memory 134, Input/Output (I/O) devices 136, a network interface 138, and a data storage device 140. It should be appreciated that FIG. 6 depicts the computing system 130 in a simplified manner, where some embodiments may include additional components and suitably configured processing logic to support known or conventional operating features. The components (i.e., 132, 134, 136, 138, 140) may be communicatively coupled via a local interface 142. The local interface 142 may include, for example, one or more buses or other wired or wireless connections. The local interface 142 may also include controllers, buffers, caches, drivers, repeaters, receivers, among other elements, to enable communication. Further, the local interface 142 may include address, control, and/or data connections to enable appropriate communications among the components 132, 134, 136, 138, 140.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Furthermore, the computing system 130 may include a microservice fast-forwarding program 144, which may be configured in any suitable combination of software or firmware and implemented in the memory 134, either in physical or virtual memory, and/or hardware implemented in the processing device 132. In some embodiments, the microservice fast-forwarding program 144 may be stored in non-transitory computer-readable media (e.g., the memory 134) and may include logic code and/or instructions that enable or cause the processing device 132 to perform certain actions, such as those described in the present disclosure for requesting and responding to requests in a microservice chain. The microservice fast-forwarding program 144 may be configured to execute the various functions described in the present disclosure for forwarding binary data in various data formats from one microservice to another. In some embodiments, the microservice fast-forwarding program 144 may be executed by any of the microservices in the chain, while in other embodiments, the actions may be performed by the “provider microservice” (i.e., microservice 12-n) for adding a tag that instructs the intermediate microservices to simply forward the data without performing the normal (yet extra) operations of memory allocation, copying, freeing, etc.

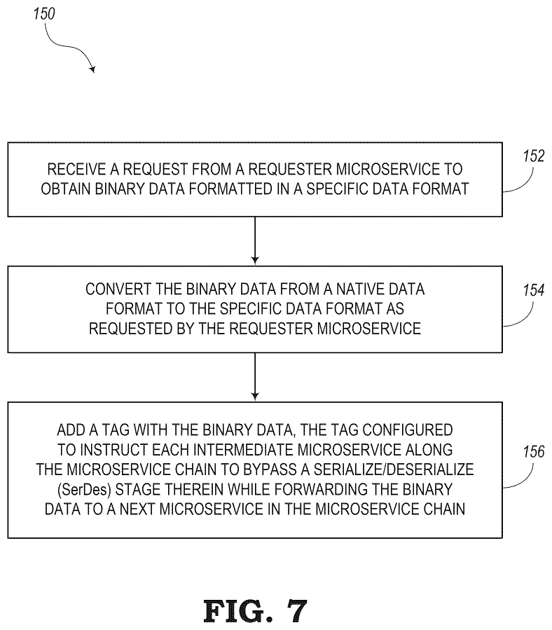

FIG. 7 is a flow diagram illustrating an embodiment of a process 150 for transmitting data in a “fast-forward” manner within a microservice chain. The process 150 may be performed by a processor, computer, microservice, NE, node, etc. that has at least the same or greater processing and computing capabilities compared with the other processors, computers, microservices, NEs, nodes, etc. in the microservice chain. Also, the process 150, in particular, may be performed by the “provider microservice” that is arranged at one end of the chain and is configured to receive a request for binary data from a “requester microservice” at the other end of the chain. In addition to returning the requested binary data, the provider microservice also applies a tag that indicates to intermediate microservices up the chain to leave the data alone and merely forward it to the next microservice, thereby avoiding extra steps of memory allocation, copying, etc.

As illustrated in FIG. 7, the process 150 includes a step of receiving a request from a requester microservice to obtain binary data formatted in a specific data format, as indicated in block 152. The process 150 further includes a step of converting the binary data from a native data format to the specific data format as requested by the requester microservice, as indicated in block 154. Also, the process 150 includes a step of adding a tag with the binary data, as indicated in block 156, wherein the tag is configured to instruct each intermediate microservice along the microservice chain to bypass a Serialize/Deserialize (SerDes) stage therein while forwarding the binary data to a next microservice in the microservice chain.

According to some embodiments, the tag (described in block 156) may be further configured to instruct each intermediate microservice along the microservice chain to bypass one or more steps associated with at least one of a binary-to-text decoding stage, a text-to-binary re-encoding stage, a memory allocation stage, and a data copying stage therein. In some embodiments, each microservice of the microservice chain may include a microprocessor and may be associated with an embedded system, node, or Network Element (NE) that is part of a distributed system. Also, in alternative embodiments, the microservice chain may be configured in a system having a single processor and shared memory address space, wherein the tag may be related to a pointer that points to locations within the shared memory address space.

Furthermore, according to various implementations, the native format and the specific data format may be categorized as flexible, schema-agnostic formats used for transmitting management information in a control plane. The flexible, schema-agnostic formats, for example, may include JSON, XML, YAML, and/or other various formats. Alternatively, the native format and the specific data format may be categorized as inflexible, firmly structured formats for transmitting data traffic in a data plane. The inflexible, firmly structured formats, for example, may include JPEG, GIF, protobuf, TCP, IP, IEEE 802.3 Ethernet packets, and/or other various formats.

In some embodiments of the process 150, the tag may be configured as metadata and stored or encapsulated in a header or footer. The tag may be configured to instruct the intermediate microservices to fast-forward the binary data in an opaque manner, avoid conversion to Base64 format, and bypass a plaintext serialization stage. The binary data, for example, may include a data file, a picture file, pre-serialized data, generated data, performance logs, a word processing document, and/or other types of data. Upon adding the tag, the process 150 may further include a steps of performing a pre-serialization of the binary data and passing the pre-serialized binary data and tag to a neighboring microservice in the microservice chain. In some embodiments, the tag may enable the neighboring microservice and/or intermediate microservices to reduce overhead, reduce CPU cycles, reduce memory allocation actions, reduce copying actions, reduce pointer freeing actions, reduce comparison actions, reduce filtering actions, reduce logging actions, and/or reduce debugging actions.

Furthermore, according to some embodiments, the request (block 152) is a binary version of a get command that is passed along the microservice chain from the requester microservice to the provider microservice. The process 150 may further include a step of pre-formatting the binary data in a binary buffer with a reference pointing to a shared memory address space, wherein the reference may be stored as metadata and included as a footer or header with respect to a payload related to the binary data to be transmitted through the microservice chain. The metadata, for example, may include an indication of at least what portions of a message contain the binary data, where the binary data is contained in the message, and a number of bytes of the binary data.

The process 150, in some embodiments, may further include steps of a) sending gNMI data, b) configuring the resource owner as a modem to generate a constellation, c) sending the binary data transparently without encoding, and/or d) encrypting the binary data that intermediate microservices cannot access but can only forward the binary data opaquely, whereby the requester microservice is able to decrypt the encrypted binary data. The binary data, in some cases, can include multiple chunks or blobs of data concatenated together, wherein the process 150 may further include a step of incorporating metadata with the binary data to define each chunk or blob.

The tag in the schema data may be used to indicate that a field should be serialized as binary data. Serialization that detects these tags and generates serialized data with raw pointers to the binary data is considered to be novel with respect to conventional systems. Also, messaging layers that can send and receive the buffers with serialized data are considered to be novel. Furthermore, the present disclosure includes a buffer that is organized to reduce or eliminate the need for copy operations in the same address space. Also, deserialization that detects this format and regenerates language specific code with references to this binary data, as described herein, is also regarded as novel. Hooks that allow for copy/free/comparison operations on the binary data that reduce or eliminate copy operations within the same address space are further aspects that separate the embodiments of the present disclosure from conventional systems.

Some operating principles of the various embodiments described herein may include one aspect that includes adding an element to the schema language to identify an element as “opaque binary.” The present systems can generate metadata for this element that contains address, offset, and length information so its location in an opaque buffer can be tracked as it flows. Also, applications can perform steps of generating binary data and supplying the address and length to the internal structure. The systems herein may also indicate which buffers are freeable and which ones are contained inside a larger structure. In addition, the present systems can also indicate names of objects and formats for decoding on the other side.

Additional operational principles may include metadata that can track the number of references and code in order to increment and decrement references when copy/free is requested. When the number of references drops to zero, the buffer can be freed. Also, the embodiments described herein may include a step of modifying SerDes code for messaging in order to detect this type of data and move/copy the binary data to the serialized buffer with information in a serialized header on where the data resides in the buffer, such as by changing the address in the structure to be an offset in a flat non-addressed buffer instead.

The operation principles of the present disclosure also allow applications to supply or access additional metadata so that when deserialized on the client, the following can be determined:
(1) Type of data (e.g., gNMI, JSON, JPEG, GIF, Wiretrace capture, perf data, etc.),
(2) Length of data, and
(3) Receiver of the data.

Once the buffer is deserialized on the receiver, the embodiment described herein may also be configured to re-use the binary buffer and adjust the offsets in the metadata to refer to real addresses inside the buffer, thereby avoiding a copy if possible. Also, the systems can decode the header to an internal structure and call the handler for this buffer. If processing is needed to recover the binary data, the type (e.g., JPEG, GIF, etc.) can be extracted so the client can properly process it.

Again, some benefits of the various embodiments described in the present disclosure may include a reduction in processing time due to reduced serialization/deserialization time and reduction in copy/free operations. Also, the systems allow for faster telemetry streams since data can be encoded on a different processor in parallel and simply passed as pre-encoded data through a would-be bottleneck. In addition, the systems and methods of the present disclosure can open up possibilities for sending other binary data, such as logs, images, encrypted data in YANG, schema-based APIs, or the like, which might not normally be able to handle this data.

### Conclusion

As described in the present disclosure and in the following claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings or claims in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing are contemplated. Furthermore, the separation of system components described should not be interpreted as mandatory for all implementations, as the program components and systems can be integrated into a single software product or distributed across multiple software products.

What is claimed is:

1. An apparatus comprising one or more processors configured to implement a provider microservice configured in a microservice chain that includes a requester microservice arranged at a first endpoint thereof and the provider microservice arranged at a second endpoint thereof, the one or more processors are configured for the provider microservice to implement steps of:
receiving a request from the requester microservice to obtain binary data formatted in a specific data format;
converting the binary data from a native data format to the specific data format as requested by the requester microservice; and
adding a tag with the binary data, the tag configured to instruct each intermediate microservice along the microservice chain to bypass a Serialize/Deserialize (SerDes) stage therein while forwarding the binary data to a next microservice in the microservice chain.

2. The apparatus of claim 1, wherein the tag is further configured to instruct each intermediate microservice along the microservice chain to bypass one or more steps associated with at least one of a binary-to-text decoding stage, a text-to-binary re-encoding stage, a memory allocation stage, and a data copying stage therein.

3. The apparatus of claim 1, wherein each microservice of the microservice chain includes a microprocessor and is associated with an embedded system, node, or Network Element (NE) that is part of a distributed system.

4. The apparatus of claim 1, wherein the microservice chain is configured in a system having a single processor and shared memory address space, and wherein the tag is related to a pointer that points to locations within the shared memory address space.

5. The apparatus of claim 1, wherein the native data format and the specific data format are categorized as flexible, schema-agnostic formats used for transmitting management information in a control plane.

6. The apparatus of claim 5, wherein the flexible, schema-agnostic formats include one or more of at least JSON, XML, and YAML.

7. The apparatus of claim 1, wherein the native data format and the specific data format are categorized as inflexible, firmly structured formats for transmitting data traffic in a data plane.

8. The apparatus of claim 7, wherein the inflexible, firmly structured formats include one or more of at least JPEG, GIF, protobuf, TCP, IP, and IEEE 802.3 Ethernet packets.

9. The apparatus of claim 1, wherein the tag is configured as metadata and is stored or encapsulated in a header or footer, and wherein the tag is configured to instruct one or more intermediate microservices to fast-forward the binary data in an opaque manner, avoid conversion, and bypass a plaintext serialization stage.

10. The apparatus of claim 1, wherein the binary data includes one or more of a data file, a picture file, pre-serialized data, generated data, performance logs, and a word processing document.

11. The apparatus of claim 1, wherein, upon adding the tag, the provider microservice is configured to perform pre-serialization of the binary data and pass the pre-serialized binary data and tag to a neighboring microservice in the microservice chain.

12. The apparatus of claim 11, wherein the tag enables the neighboring microservice and/or intermediate microservices to reduce overhead, reduce CPU cycles, reduce memory allocation actions, reduce copying actions, reduce pointer freeing actions, reduce comparison actions, reduce filtering actions, reduce logging actions, and/or reduce debugging actions.

13. The apparatus of claim 1, wherein the request is a binary version of a command that is passed along the microservice chain from the requester microservice to the provider microservice.

14. The apparatus of claim 1, further comprising a step of pre-formatting the binary data in a binary buffer with a reference pointing to a shared memory address space, the reference stored as metadata and included as a footer or header with respect to a payload related to the binary data to be transmitted through the microservice chain.

15. The apparatus of claim 14, wherein the metadata includes an indication of at least what portions of a message contain the binary data, where the binary data is contained in the message, and a number of bytes of the binary data.

16. The apparatus of claim 1, further comprising performing one or more steps of a) sending gNMI data, b) acting as a modem and generating a constellation, c) sending the binary data transparently without encoding, and d) encrypting the binary data that intermediate microservices cannot access but can only forward the binary data opaquely, whereby the requester microservice is able to decrypt the encrypted binary data.

17. The apparatus of claim 1, wherein the binary data includes multiple chunks or blobs of data concatenated together, and wherein the provider microservice further includes a step of incorporating metadata with the binary data to define each chunk or blob.

18. A method associated with a provider microservice configured in a microservice chain including a requester microservice arranged at a first endpoint thereof and the provider microservice arranged at a second endpoint thereof, the method comprising steps of:
receiving a request from the requester microservice to obtain binary data formatted in a specific data format;
converting the binary data from a native data format to the specific data format as requested by the requester microservice; and
adding a tag with the binary data, the tag configured to instruct each intermediate microservice along the microservice chain to bypass a Serialize/Deserialize (SerDes) stage therein while forwarding the binary data to a next microservice in the microservice chain.

19. The method of claim 18, wherein the tag is further configured to instruct each intermediate microservice along the microservice chain to bypass one or more steps associated with at least one of a binary-to-text decoding stage, a text-to-binary re-encoding stage, a memory allocation stage, and a data copying stage therein.

20. A non-transitory computer-readable medium associated with a provider microservice configured in a microservice chain including a requester microservice arranged at a first endpoint thereof and the provider microservice arranged at a second endpoint thereof, the non-transitory computer-readable medium configured to store computing logic having instructions that, when executed, enable one or more processing devices to perform steps of:
receiving a request from the requester microservice to obtain binary data formatted in a specific data format;
converting the binary data from a native data format to the specific data format as requested by the requester microservice; and
adding a tag with the binary data, the tag configured to instruct each intermediate microservice along the microservice chain to bypass a Serialize/Deserialize (SerDes) stage therein while forwarding the binary data to a next microservice in the microservice chain.
